(19) United States
(12) Patent Application Publication
(10) Pub. No.: US 2022/0319505 A1
(43) Pub. Date: Oct. 6, 2022

(54) SYSTEM AND METHOD FOR RAPID IMPROVEMENT OF VIRTUAL SPEECH AGENT'S NATURAL LANGUAGE UNDERSTANDING

(71) Applicant: Ashwarya Poddar, Kirkland, WA (US)

(72) Inventor: Ashwarya Poddar, Kirkland, WA (US)

(21) Appl. No.: 17/698,288

(22) Filed: Mar. 18, 2022

Related U.S. Application Data
(60) Provisional application No. 63/148,691, filed on Feb. 12, 2021.

(51) Int. Cl. G10L 15/18; G10L 15/06; G10L 15/30; G10L 15/22; H04M 3/51

(52) U.S. Cl. CPC G10L 15/1815; G10L 15/063; G10L 15/30; G10L 15/22; H04M 3/5183; G10L 2015/0635; G10L 2015/0638; G10L 2015/225

(57) ABSTRACT

A system for the rapid improvement of a virtual speech agent's natural language processing is disclosed, including a virtual agent to execute a phone call between the virtual agent and a user. The virtual agent identifies and transmits problematic segments within a dialogue to a classifier to categorize into one of the following: an unanswered question, a mismatched intent, and a missed intent. A custom transcript model is created using the corrected transcript snippet, the incorrect transcript snippet, and the recording snippet of the problematic segments. A human teacher may then update the NLU model's intent understanding by looking at the feedback report and taking action to make the correction.

### CROSS-REFERENCE TO RELATED APPLICATIONS

The present application claims priority to U.S. Provisional Patent Application No. 63/148,691 filed Feb. 12, 2021, entitled “SYSTEM AND METHOD FOR RAPID IMPROVEMENT OF VIRTUAL SPEECH AGENTS NATURAL LANGUAGE PROCESSING,” which is hereby incorporated by reference in its entirety.

### TECHNICAL FIELD

The embodiments generally relate to computerized systems for improving a virtual speech agent's natural language understanding.

### BACKGROUND

Virtual speech agents are used to conduct conversations in lieu of providing direct contact with a live human agent. These systems are designed to simulate the way a human would behave as a conversational partner. Often, these systems require continuous tuning and testing to be effective. However, many of these systems remain unable to adequately converse with a human. Some of these applications simply scan for general keywords and generate responses using common phrases obtained from an associated library or database.

More advanced virtual speech agent systems now use extensive word-classification processes, natural language processors, and sophisticated artificial intelligence. Systems in the current arts have various limitations including the inability to manage multiple inquiries at once, limitations in language processing, lack of conversational data, and the inability to engage in non-linear conversations.

For improving natural language understanding models, most companies use human teachers who teach a machine to understand the intent of phrases and sentences from documents. To improve transcript quality of Speech-to-Text, most companies use a combination of automated transcripts, manual transcripts and recording files for model improvement. Moreover, most companies provide services to analyze voice recorded conversations. For this, companies use the above mechanisms to first improve transcription quality followed by improvement in natural language understanding (NLU) models.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A system for the rapid improvement of a virtual speech agent's natural language processing is disclosed, including a virtual agent to execute a phone call between the virtual agent and a user. The virtual agent identifies and transmits problematic segments within a dialogue to a classifier to categorize into one of the following: an unanswered question, a mismatched intent, and a missed intent. A custom transcript model is created using the corrected transcript snippet, the incorrect transcript snippet, and the recording snippet of the problematic segments. A human teacher may then update the NLU model's intent understanding by looking at the feedback report and taking action to make the correction.

The embodiments provide an AI powered conversational virtual speech agent that can interact with an end-user over a telephone or similar communications device. The virtual speech agent can understand the user using natural language processing and can have a real time vocal conversation with the user on a phone call. These phone calls are recorded in a legally compliant manner for review later. At the end of the call, the system can send a conversation summary with insights to the company for whom the system makes the call to a user. The system also provides a robust feedback loop mechanism that will enable the virtual speech agent to rapidly improve its understanding of the natural language and engage in increasingly human-like conversation with users over time.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates a flowchart of a method for the virtual speech agent's natural language understanding improvement with a robust feedback loop, according to some embodiments;

FIG. 1B illustrates a flowchart of a method for the virtual speech agent's natural language understanding improvement with a robust feedback loop, according to some embodiments;

FIG. 2 illustrates a block diagram of the application program, according to some embodiments; and

FIG. 3 illustrates a screenshot of a feedback report, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to systems and methods for the rapid improvement of a virtual speech agent's natural language processing having a robust feedback loop. The system includes an AI powered conversational virtual speech agent that can interact with an end-user over a telephone or similar communications device. The virtual speech agent can understand the user using natural language processing and can have a real time vocal conversation with the user on a phone call. These phone calls are recorded in a legally compliant manner for review later. At the end of the call, the system can send a conversation summary with insights to the company for whom the system makes the call to a user. The system also provides a robust feedback loop mechanism that will enable the virtual speech agent to rapidly improve its understanding of the natural language and engage in increasingly human-like conversation with users over time.

The embodiments provide a unique feedback loop for improving the NLU model for vocal conversations between a virtual agent and a human. This solution can be used to improve the conversational models for any conversation between a virtual agent and a human, such as customer service conversation between a virtual customer service agent and a human customer, sales conversation between a virtual seller agent and a human customer or a recruiting conversation between a virtual recruiter and a human candidate.

To improve the NLU models, one can manually review the entire conversation by listening to the recording file and reviewing the corresponding transcript to identify spots in the conversation when the transcription was incorrect as well as spots where a virtual agent could not handle the conversation as a human would typically do.

The system can identify problematic segments in a conversation using a combination of pre-configured hooks on the virtual agent. This can be done by capturing all the segments when the virtual agent failed to give a specific answer and had to resolve to a graceful generic response, leveraging conversation insights service to identify segments in which no insights were generated at times when insights were expected. Further, machine learning techniques can be used to identify unpleasant situations in a conversation. For the problematic segments the snippet of the transcript is extracted as well as the call recording. By doing this the system does not need to access the full transcript or the full call recording to make improvements to the virtual agent but can only pick segments that specifically need improvement. The system may then categorize the problematic segments into one of the following categories; unanswered questions, mismatched intent and missed intent.

The system then generates a feedback report that contains just the segments (snippets of the recording file and snippets of the transcript). The embodiments provide a highly efficient and focused approach for updating the natural language understanding AI model and transcription model. The system also creates a foundation to build robust virtual speech agent that can have deep natural language understanding.

The embodiments provide a unique feedback loop for the virtual agent. The entire conversation is separated into questions and answers. Problematic segments in a conversation are identified using a combination of pre-configured hooks on the virtual agent i.e., capturing all the segments when the virtual agent failed to give a specific answer and had to resolve to a graceful generic response, leveraging conversation insights service to identify segments where no insights were generated while insights were expected to be generated and using machine learning techniques to identify unpleasant situations in a conversation. For the problematic segments, the snippet is extracted of the transcript as well as the call recording. By doing this the system does not need to access the full transcript or the full call recording to make improvements to the agent but can only pick segments that specifically need improvement. We then categorize the problematic segments into unanswered questions, mismatched intent and missed intent. We then generate a feedback report that contains just the segments (e.g., snippets of the recording file and transcript rather than full conversation) of the conversation where we noticed improvement opportunities. By using these segments, the system can be utilized to efficiently make improvements to the custom transcription as well as the NLU models for the virtual speech agent.

The problematic segments are available in a transcript correction tool that human transcribers use to correct and submit transcript segments for further processing. Once submitted, the erroneous transcript segment, the correct transcript segment and the call recording segment is fed into a custom transcript model for retraining. In parallel, the automated feedback report with categorized segments, corresponding to corrected transcript snippet and call recording snippet is sent to human teachers to make updates to the agent's NLU model as well as for adding new responses to the agent's answers repository.

By identifying problematic segments, categorizing the segments, and by using the snippets of just the transcript and call recording the system provides high efficiency and focus for updating the natural language understanding AI model and the custom transcription model. By feeding the segments into the transcript correction tool followed by the unique feedback report that human teachers can use to review the problematic segments and update the NLU model, the systems create a robust end to end mechanism to rapidly improve the conversational AI system.

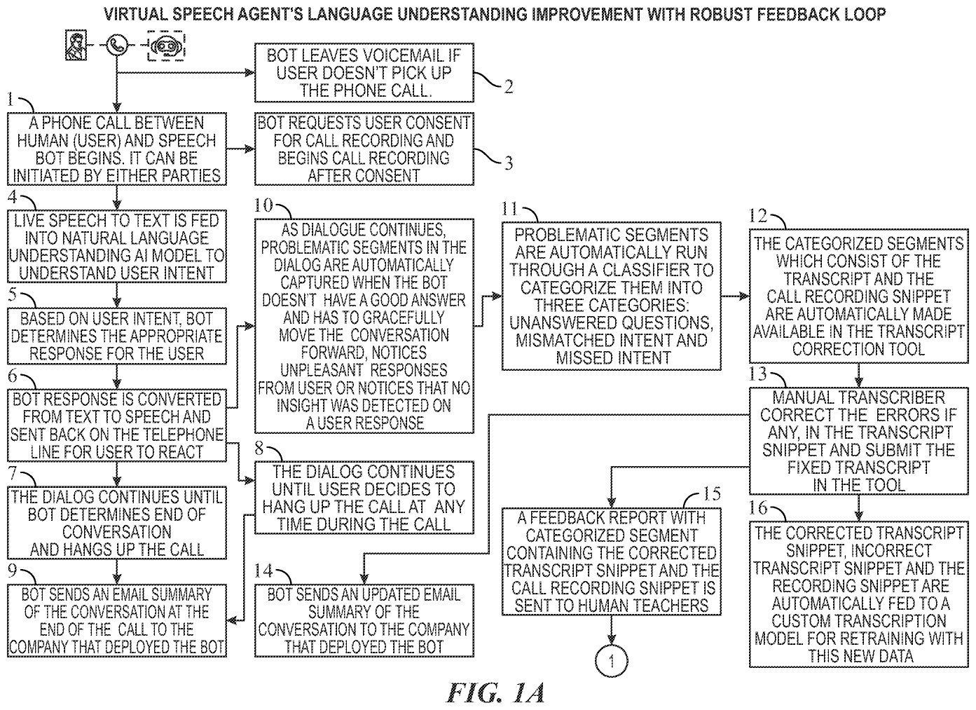

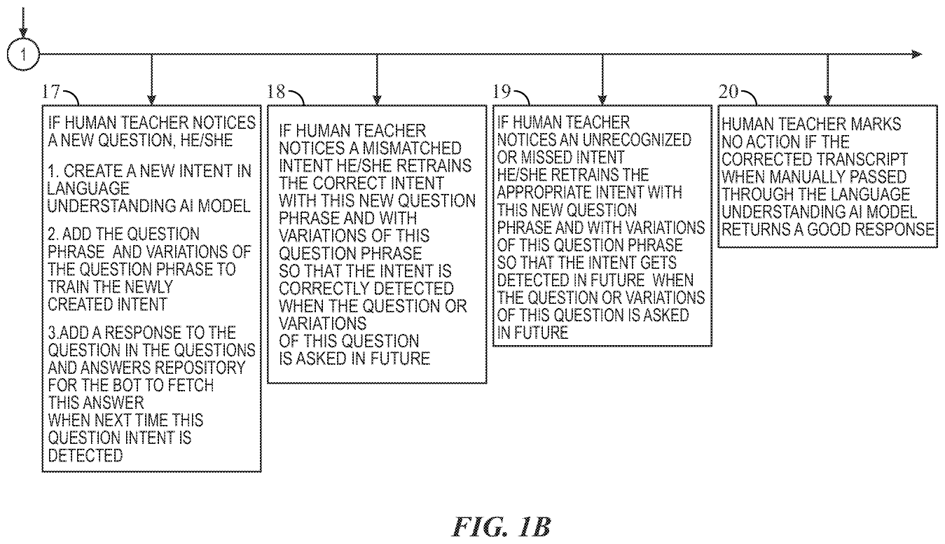

FIG. 1A illustrates a flowchart of the method for the rapid improvement of a virtual speech agent's natural language processing. In block 1 a phone call between a human (i.e., the user) and a virtual agent begins. In block 2, the virtual agent may leave a voicemail if the user does not answer the phone call. In block 3, the virtual agent requests the user's consent for the call to be recorded and begins recorded once consent is given. In block 4, live speech to text is fed into the NLU AI model to understand the user's intent throughout the conversation. In block 5, the virtual agent determines the appropriate response based on the user's intent. In block 6, the virtual agent's response is converted from text-to-speech and sent to the user via the telephone. In block 7 and block 8, the dialog continues until the virtual agent determines the conversation has ended or the user ends the call. In block 9, the virtual agent sends an email summary of the conversation to the company that deployed the virtual agent. In block 10, problematic segments are captured when the virtual assistant is unable to provide a suitable answer. In block 11, the problematic segments are automatically run through a classifier to categorize them into one of the three categories: unanswered, mismatched intent, and missed intent. In block 12, the categorized segments are automatically made available in the transcription correction tool. In block 13, a manual transcriber corrects the errors and submits the corrections via the transcription correction tool. In block 14, the virtual agent sends an updated email to the company that deployed the virtual agent. In block 15, a feedback report with the categorized segment containing the corrected transcript snippet and call recording snippet is sent to a human teacher. In block 16, the corrected transcript snippet, incorrect transcript snippet, and the recording snippet are transmitted to a custom transcription model for retraining using the new data.

FIG. 1B illustrates a continued flowchart of the method for the rapid improvement of a virtual speech agent's natural language processing. In block 17, if the human teacher notices a new question, they may select to perform at least one of the following: create a new intent, add the question and various of the question to train the newly created intent, and add a response to the question and answers to the repository. In block 18, if the human teacher notices a mismatched intent, they may retrain the correct intent such that the intent is correctly detected. In block 19, if the human teacher notices an unrecognized or missed intent, they may retrain the appropriate intent with the new questions phrase and variations of this question phrase. In block 20, the human teacher marks no action if the corrected transcript, when manually passed through the NLU AI model, returns a suitable response.

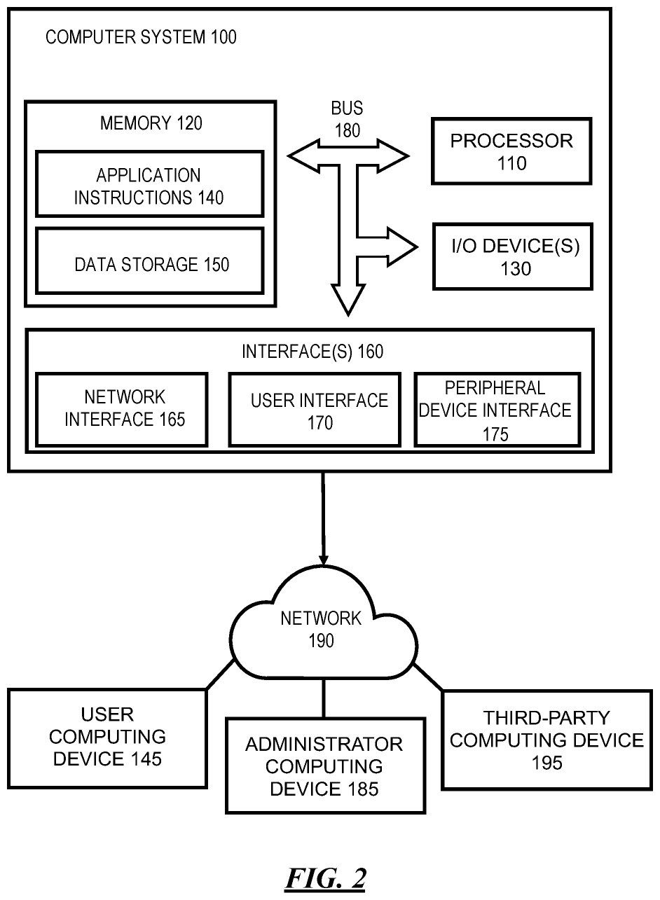

FIG. 2 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the systems functionalities. The administrator computing device 185 is utilized by an administrative user to moderate content and to perform other administrative functions.

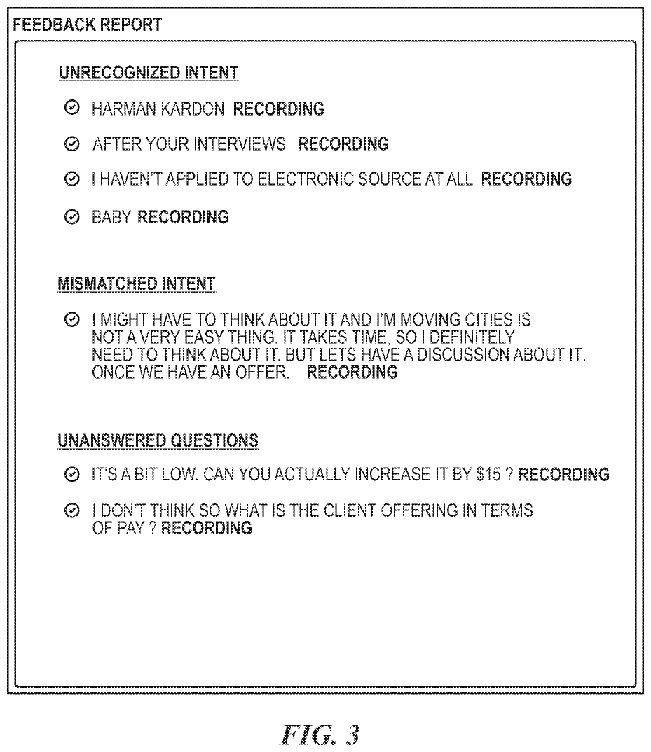

FIG. 3 illustrates a screenshot of an exemplary feedback report 300 generated by the system. The feedback report includes the identified and classified problematic segments. In the illustrated example, the feedback report has categorized the problematic segments into the following categories: unrecognized intent, mismatched intent, and unanswered questions. In such, the feedback report contains just the segments (e.g., snippets of the recording file and transcript rather than full conversation) of the conversation where we noticed improvement opportunities. By using these segments, the system can be utilized to efficiently make improvements to the custom transcription as well as the NLU models for the virtual speech agent.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for the rapid improvement of a virtual speech agent's natural language processing:
a virtual agent to execute a phone call between the virtual agent and a user, wherein the virtual agent automatically identifies and transmits problematic segments within a dialogue to a classifier to categorize into one of the following: an unanswered question, a mismatched intent, and a missed intent, wherein the virtual agent automatically generates a feedback report of the problematic segments with snippets of the transcript and call recordings; and
a manual transcriber to correct the errors in the problematic segments, wherein a human teacher updates an NLU model's intent understanding.

2. The system of claim 1, wherein the phone call is initiated by the speech agent or the user.

3. The system of claim 2, wherein a bot requests consent from the user for a recording of the phone call.

4. The system of claim 3, wherein the live speech to text is fed into a natural language processing AI model to facilitate the understanding of an intent.

5. The system of claim 4, wherein a bot determines a response based on the intent.

6. The system of claim 5, wherein a feedback report contains one or more transcript snippets and one or more call recording snippets categorized into problematic segments.

7. A system for interacting with building and construction permits, the system comprising:
at least one user computing device in operable connection with a user network;
an application server in operable communication with the user network, the application server configured to host an application system for providing a system for the rapid improvement of a virtual speech agent's natural language processing, the application system having a user interface for providing access to the application system through the user computing device;
a virtual agent to execute a phone call between the virtual agent and a user, wherein the virtual agent automatically identifies and transmits problematic segments within a dialogue to a classifier to categorize into one of the following: an unanswered question, a mismatched intent, and a missed intent, wherein the virtual agent automatically generates a feedback report of the problematic segments with snippets of the transcript and call recordings; and
a manual transcriber to correct the errors in the problematic segments, wherein a human teacher updates an NLU model's intent understanding.

8. The system of claim 7, wherein the phone call is initiated by the speech agent or the user.

9. The system of claim 8, wherein a bot requests consent from the user for a recording of the phone call.

10. The system of claim 9, wherein the live speech to text is fed into a natural language processing AI model to facilitate the understanding of an intent.

11. The system of claim 10, wherein a bot determines a response based on the intent.

12. The system of claim 11, wherein a feedback report contains one or more transcript snippets and one or more call recording snippets categorized into problematic segments.

13. A method for the rapid improvement of a virtual speech agent's natural language processing, the method comprising the steps of:
executing a phone call between a virtual speech agent and a user;
identifying and transmitting one or more problematic segments separated into a plurality of snippets of a call recording within a dialogue to a classifier;
classifying the problematic segments into on the following categories: an unanswered question, a mismatched intent, and a missed intent;
correcting, via a manual transcriber, the errors in the transcript of the problematic segments; and
updating, via a human teacher, the NLU model's intent understanding using a feedback report.

14. The method of claim 13, wherein the phone call is initiated by the speech agent or the user.

15. The method of claim 14, further comprising the step of: requesting, via a bot, consent from the user for a recording of the phone call.

16. The method of claim 15, further comprising the step of: feeding the live speech to text into a natural language processing AI model to facilitate the understanding of an intent.

17. The method of claim 16, further comprising the step of: determining, via the bot, a response based on the intent.

18. The method of claim 17, wherein a feedback report contains transcript snippets and call recording snippets categorized into problematic segments.
